(19) United States
(12) Patent Application Publication
(10) Pub. No.: US 2014/0322471 A1
(43) Pub. Date: Oct. 30, 2014

(54) Phosphor-Containing Composite Material Having Two Exposed Adhesive Surfaces and Optical Article Including the Same

(71) Applicant: Genius Electronic Optical Co., Ltd., Taichung City (TW)

(72) Inventors: Chieh-Chung Liu, Taichung City (TW); Chi-Yung Hung, Taichung City (TW); Chih-Kuang Tai, Taichung City (TW)

(21) Appl. No.: 14/329,390

(22) Filed: Jul. 11, 2014

Related U.S. Application Data
(63) Continuation-in-part of application No. 13/463,925, filed on May 4, 2012.

(30) Foreign Application Priority Data
May 4, 2011 (TW) 100207910

(51) Int. Cl. C09K 11/02

(52) U.S. Cl. CPC C09K 11/025
USPC 428/41.7

(57) ABSTRACT

A phosphor-containing composite material comprises: an optical excitable film including a releasable adhesive matrix and a phosphor dispersed in the releasable adhesive matrix, the optical excitable film having first and second exposed adhesive surfaces; and a transparent first releasable protection layer having a first surface bonded peelably to the first exposed adhesive surface of the optical excitable film. The optical excitable film is one single layer. A second surface of the first releasable protection layer is free from attachment of any adhesive material.

### CROSS-REFERENCE TO RELATED APPLICATION

This application is a continuation-in-part (CIP) of U.S. patent application Ser. No. 13/463925, filed on May 4, 2012, the entire disclosure of which is incorporated herein by reference.

### BACKGROUND OF THE INVENTION

1. Field of the Invention

The invention relates to a phosphor-containing composite material and an optical article including the same, and more particularly to a phosphor-containing composite material including an optical excitable film and a releasable liner layer bonded peelably to the optical excitable film.

2. Description of the Related Art

U.S. Patent Application Publication No. 2004/0202812 (Congard et al.) discloses a conventional photoluminescent adhesive tape that includes first and second exposed adhesive layers, an intermediate backing layer that is disposed between the first and second exposed adhesive layers, and a photoluminescent agent. The photoluminescent agent may be mixed into one of the first and second exposed adhesive layers or the backing layer, or employed as a separate layer, such as a photoluminescent ink layer, added into other layers of the photoluminescent adhesive tape. The first and second exposed adhesive layers are made from pressure sensitive adhesives (PSA), and are preferably protected by first and second release liners prior to use. In use, when a first substrate is to be attached to a second substrate, the first exposed adhesive layer may be bonded to the first substrate and the second exposed adhesive layer may be bonded to the second substrate. Congard et al. also teach that a primer or an adhesion promoter may be applied to the backing layer and/or the photoluminescent ink layer to ensure adequate anchorage of the first and second adhesive layers and/or the photoluminescent ink layer to the backing layer.

The aforesaid conventional photoluminescent adhesive tape has a multi-layered structure including at least three basic layers, i.e., the backing layer and the first and second exposed adhesive layers, which tends to result in the following disadvantages. First, the first and second exposed adhesive layers have a tendency to be peel-off from the backing layer when the conventional photoluminescent adhesive tape is repeatedly bent for a number of times during processing thereof. Secondly, when the conventional photoluminescent adhesive tape is exposed to a high temperature environment, the first and second exposed adhesive layers also have a tendency to be peel-off from the backing layer due to different thermal expansion coefficients of the first and second exposed adhesive layers and the backing layer. Thirdly, since the aforesaid conventional photoluminescent adhesive tape includes at least three different layers, which have different refractive indices, the same has a tendency of generating total internal reflection therein, which results in a decrease in the light transmission thereof.

### SUMMARY OF THE INVENTION

Therefore, the object of the present invention is to provide a phosphor-containing composite material that can overcome the aforesaid drawback associated with the prior art.

Another object of this invention is to provide a phosphor-containing optical article that includes the phosphor-containing composite material.

According to one aspect of the present invention, there is provided a phosphor-containing composite material that comprises: an optical excitable film including a releasable adhesive matrix and a phosphor dispersed in the releasable adhesive matrix, the optical excitable film having opposite first and second exposed adhesive surfaces, the second exposed adhesive surface being adapted to be peelably bonded to an external element; and a transparent first releasable protection layer having first and second surfaces that are opposite to each other along a stacking direction. The first surface of the first releasable protection layer is bonded to and is stacked on the first exposed adhesive surface along the stacking direction. The second surface of the first releasable protection layer is free from attachment of any adhesive material. The optical excitable film is one single layer. The transparent first releasable protection layer is peelable to expose the first exposed adhesive surface when the second exposed surface is peelably bonded to the external element.

According to another aspect of the present invention, there is provided a phosphor-containing optical article that comprises an optical element; and a phosphor-containing composite material. The phosphor-containing composite material comprises: an optical excitable film including a releasable adhesive matrix and a phosphor dispersed in the releasable adhesive matrix, the optical excitable film having opposite first and second exposed adhesive surfaces, the second exposed adhesive surface being peelably bonded to the optical element; and a transparent first releasable protection layer having first and second surfaces that are opposite to each other along a stacking direction. The first surface of the first releasable protection layer is bonded to and is stacked on the first exposed adhesive surface along the stacking direction. The second surface of the first releasable protection layer is free from attachment of any adhesive material. The optical excitable film is one single layer. The transparent first releasable protection layer is peelable to expose the first exposed adhesive surface.

According to yet another aspect of the present invention, there is provided a phosphor-containing composite material that consists of: an optical excitable film including a releasable adhesive matrix and a phosphor dispersed in the releasable adhesive matrix, the optical excitable film having opposite first and second exposed adhesive surfaces, the second exposed adhesive surface being adapted to be peelably bonded to an external element; and a transparent first releasable protection layer bonded to the first exposed adhesive surface. The transparent first releasable protection layer is peelable to expose the first exposed adhesive surface when the second exposed adhesive surface is peelably bonded to the external element.

### BRIEF DESCRIPTION OF THE DRAWINGS

In drawings which illustrate an embodiment of the invention,

FIG. 1 is a schematic view of the preferred embodiment of a phosphor-containing composite material according to the present invention;

FIG. 2 is a fragmentary partly sectional view of an optical article including the preferred embodiment;

FIG. 3 is a fragmentary partly sectional view of a modified optical article modified from the optical article of FIG. 2; and

FIG. 4 is a schematic view of a lamp device including the preferred embodiment.

### DETAILED DESCRIPTION OF THE PREFERRED EMBODIMENT

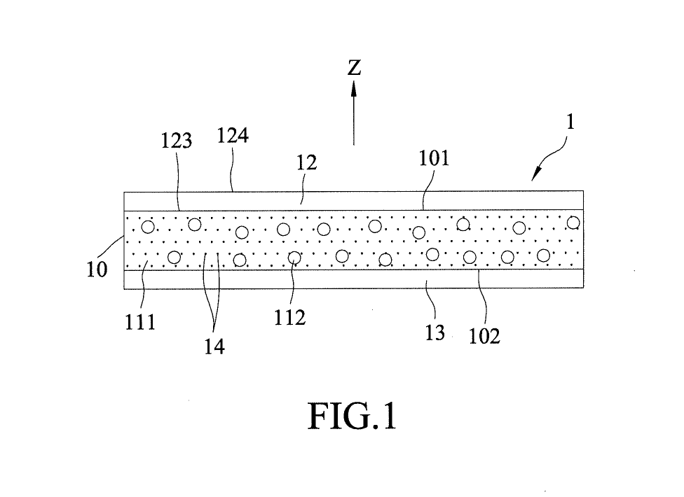

FIG. 1 illustrates the preferred embodiment of a phosphor-containing composite material 1 according to the present invention. The phosphor-containing composite material 1 can be applied to a light source, such as LEDs and lamp devices, to form an optical article.

The phosphor-containing composite material 1 includes: an optical excitable film 10 having a releasable adhesive matrix 111 and a phosphor 112 dispersed uniformly in the releasable adhesive matrix 111, the optical excitable film 10 having first and second exposed adhesive surfaces 101, 102 that are opposite to each other and a peel adhesion value ranging from 10-200 g/inch as determined by PSTC-1 (Pressure Sensitive Tape Council, 180° peel resistance test) standard test, the optical excitable film being one single layer; a transparent first releasable protection layer 12 having first and second surfaces 123, 124 that are opposite to each other along a stacking direction (Z), the first surface 123 of the first releasable protection layer 12 being stacked on and bonded peelably and directly to the first exposed adhesive surface 101 of the optical excitable film 10 along the stacking direction (Z) for protecting the optical excitable film 10 prior to use, the second surface 124 of the first releasable protection layer 12 being free from attachment of any adhesive material; and a second releasable protection layer 13 bonded peelably and directly to the second exposed adhesive surface 102 of the optical excitable film 10 for protecting the optical excitable film 10 prior to use.

When the peel adhesion value of the optical excitable film 10 is less than 10 g/inch, the adhesiveness of the optical excitable film 10 is insufficient for bonding to an object (not shown). When the peel adhesion value of the optical excitable film 10 is higher than 200 g/inch, the adhesiveness of the optical excitable film 10 is too strong that the transparent first releasable protection layer 12 and the second releasable protection layer 13 cannot be easily released therefrom.

Preferably, the releasable adhesive matrix 111 is made from an adhesive material containing a tacky polymer selected from polyacrylic acid resins, polyacrylate resins, polyisocyanate resins, and epoxy resins.

The adhesive material can further contain a crosslinking agent selected from epoxy compounds, isocynate compounds and silane-containing compounds. Preferably, the crosslinking agent is in an amount ranging from 1-5 parts by weight per 100 parts by weight of the releasable adhesive matrix 111.

Preferably, the adhesive material is prepared from a slurry containing the tacky polymer and a solvent for dissolving the tacky polymer. The slurry preferably has a viscosity ranging from 500-20000 cps at 25° C., and a solid content ranging from 25-65 wt %. After the slurry is applied to the transparent first releasable protection layer 12, the solvent is removed from the slurry by heating so as to form the releasable adhesive matrix 111 on the transparent first releasable protection layer 12.

Preferably, the transparent first releasable protection layer 12 is made from a non-tacky polymer selected from polycarbonate, polyimide, polyethersulfone, polyacrylate, polyethylene, polyethylene terephthalate, polyetheretherketone, polyethylene naphthalate, and polyetherimide. The releasable protection layer 13 can be made from a polymer the same as that of the transparent first releasable protection layer 12.

Examples of the phosphor 112 employed in the optical excitable film 10 may be those disclosed in U.S. Pat. No. 7,294,861.

The optical excitable film 10 can optionally include a plurality of quantum dots 14 dispersed in the releasable adhesive matrix 111 for enhancing the brightness of the light converted by the phosphor 112. Preferably, the weight ratio of the quantum dots 14 to the combination of the releasable adhesive matrix 111 and the phosphor 112 ranges from 0.001-0.002.

Preferably, the optical excitable film 10 includes 1 to 35 parts by weight of the phosphor 112 per 100 parts by weight of the releasable adhesive matrix 111. When the phosphor 112 is in an amount of less than 1 part per 100 parts by weight of the releasable adhesive matrix 111, the optical excitable film 10 cannot effectively convert the light from a light source into a desired color. When the phosphor 112 is in an amount higher than 35 parts per 100 parts by weight of the releasable adhesive matrix 111, non-uniform dispersion of the phosphor 112 in the releasable adhesive matrix 111 may occur and the tackiness of the releasable adhesive matrix 111 may be considerably reduced.

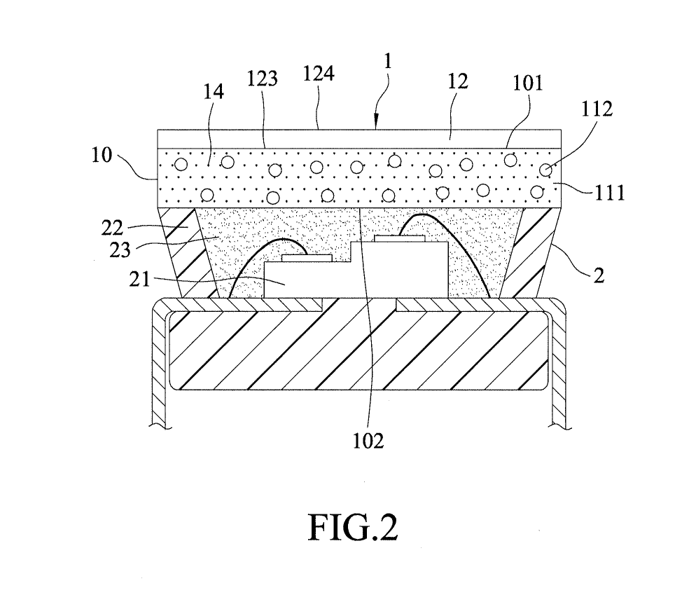

FIG. 2, in combination with FIG. 1, illustrates an application of the phosphor-containing composite material 1 to an external optical element, such as an LED package 2 or a light source, to form an optical article. The external optical element or the LED package 2 includes an LED chip 21 mounted in a cup 22 that is filled with an encapsulant 23. In this application, the second releasable protection layer 13 is peeled off from the second exposed adhesive surface 102 to permit the second exposed adhesive surface 102 of the optical excitable film 10 to be peelably bonded to a top of the cup 22 and a top surface of the encapsulant 23. The transparent first releasable protection layer 12 is peelable from the first exposed adhesive surface 101, so that when the second exposed adhesive surface 102 is peelably bonded to the LED package 2, the transparent first releasable protection layer 12 is peelable to expose the first exposed adhesive surface 101 for attachment use, such as attaching the optical article to a wall of a device (not shown). Both of the transparent first releasable protection layer 12 and the second releasable protection layer 13 of the present invention can be peelably and respectively removed from the first and second exposed adhesive surfaces 101, 102 of the optical excitable film 10 to expose the first and second exposed adhesive surfaces 101, 102 for external attachment to different objects, respectively. In addition, since the transparent first releasable protection layer 12 and the second releasable protection layer 13 are peelable respectively from the first and second exposed adhesive surfaces 101, 102, the number of layers covering the LED package 2 can be reduced to one single layer, i.e., the optical excitable film 10. On the other hand, however, the number of the layers can only be reduced to three, i.e., the first and second exposed adhesive layers and the backing layer, for the aforesaid conventional photoluminescent adhesive tape. As such, the optical article of the present invention has a thinner thickness and exhibits a better light transmission through the optical excitable film 10 as compared to those of the optical article including the aforesaid conventional photoluminescent adhesive tape through the first and second exposed adhesive layers and the backing layer. Moreover, the larger the number of the layers covering the LED package 2, the worse the wavelength shifting of the light passing therethrough can occur.

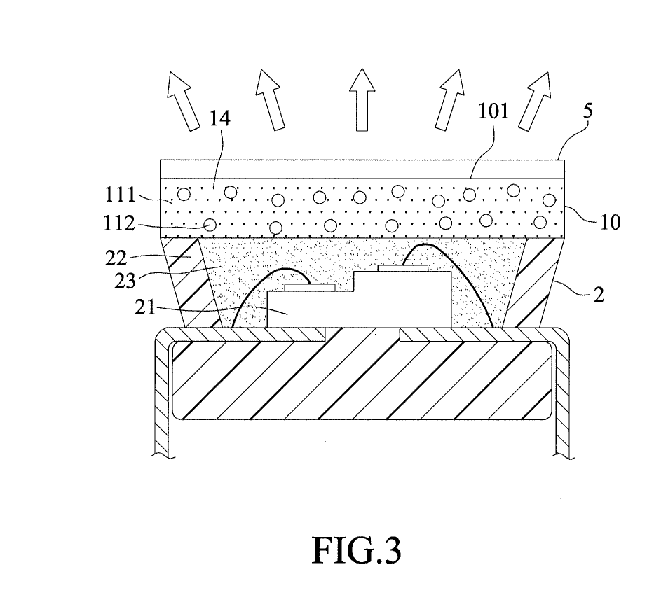

FIG. 3 illustrates a modified optical article modified from the optical article of FIG. 2 by replacing the transparent first releasable protection layer 12 with an optical element 5, such as a light guide plate, a diffuser plate, a reflector plate, a lens, and the like.

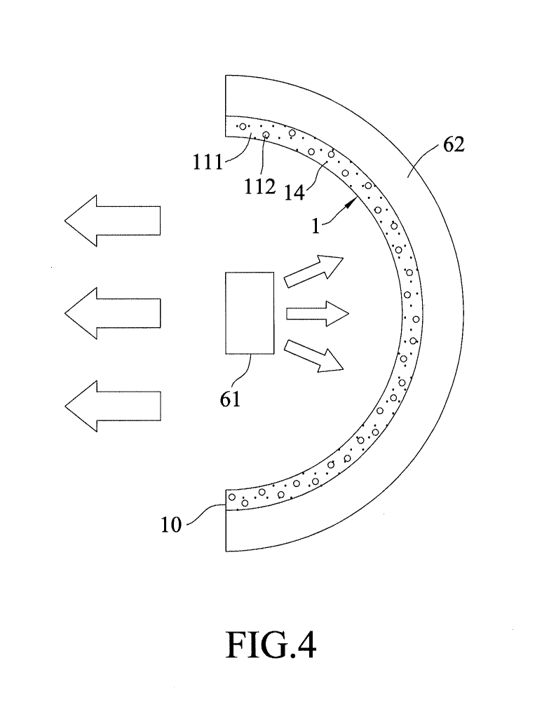

FIG. 4, in combination with FIG. 1, illustrates another application of the phosphor-containing composite material 1 to a lamp device. The lamp device includes a light source 61 and an arc-shaped reflector 62. In this application, the transparent first releasable protection layer 12 and the second releasable protection layer 13 are peeled off from the phosphor-containing composite material 1 to permit the optical excitable film 10 to be peelably bonded to an inner surface of the arc-shaped reflector 62.

By dispersing the phosphor 112 into the releasable adhesive matrix 111 of the phosphor-containing composite material 1 of this invention, the optical excitable film 10 is capable of proving a light conversion function and an adhering function. In addition, since the number of layers of the phosphor-containing composite material can be reduced to two, which is less than that of the aforesaid conventional photoluminescent adhesive tape, the aforesaid drawbacks associated with the aforesaid conventional photoluminescent adhesive tape can be alleviated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A phosphor-containing composite material comprising:
an optical excitable film including a releasable adhesive matrix and a phosphor dispersed in said releasable adhesive matrix, said optical excitable film having opposite first and second exposed adhesive surfaces, said second exposed adhesive surface being adapted to be peelably bonded to an external element; and
a transparent first releasable protection layer having first and second surfaces that are opposite to each other along a stacking direction, said first surface of said first releasable protection layer being bonded to and being stacked on said first exposed adhesive surface along the stacking direction, said second surface of said first releasable protection layer being free from attachment of any adhesive material;
wherein said optical excitable film is one single layer; and
wherein said transparent first releasable protection layer is peelable to expose said first exposed adhesive surface when said second exposed adhesive surface is peelably bonded to the external element.

2. The phosphor-containing composite material of claim 1, wherein said releasable adhesive matrix is made from an adhesive material containing a tacky polymer selected from polyacrylic acid resins, polyacrylate resins, polyisocyanate resins, and epoxy resins.

3. The phosphor-containing composite material of claim 1, wherein said transparent first releasable protection layer is made from a non-tacky polymer selected from polycarbonate, polyimide, polyethersulfone, polyacrylate, polyethylene, polyethylene terephthalate, polyetheretherketone, polyethylene naphthalate, and polyetherimide.

4. The phosphor-containing composite material of claim 1, further comprising a second releasable protection layer peelably bonded to said second exposed adhesive surface for protecting said optical excitable film.

5. The phosphor-containing composite material of claim 2, wherein said adhesive material further contains a crosslinking agent selected from epoxy compounds, isocyanate compounds and silane-containing compounds.

6. The phosphor-containing composite material of claim 1, wherein said optical excitable film further includes a plurality of quantum dots dispersed in said releasable adhesive matrix.

7. The phosphor-containing composite material of claim 1, wherein said optical excitable film includes 1 to 35 parts by weight of said phosphor per 100 parts by weight of said releasable adhesive matrix.

8. The phosphor-containing composite material of claim 1, wherein said optical excitable film has a peel adhesion value ranging from 10-200 g/inch as determined by PSTC-1 standard test.

9. A phosphor-containing optical article comprising:
an optical element; and
a phosphor-containing composite material comprising:
an optical excitable film including a releasable adhesive matrix and a phosphor dispersed in said releasable adhesive matrix, said optical excitable film having opposite first and second exposed adhesive surfaces, said second exposed adhesive surface being peelably bonded to said optical element, and
a transparent first releasable protection layer having first and second surfaces that are opposite to each other along a stacking direction, said first surface of said first releasable protection layer being bonded to and being stacked on said first exposed adhesive surface along the stacking direction, said second surface of said first releasable protection layer being free from attachment of any adhesive material,
wherein said optical excitable film is one single layer; and
wherein said transparent first releasable protection layer is peelable to expose said first exposed adhesive surface.

10. The phosphor-containing optical article of claim 9, wherein said optical element is an LED.

11. A phosphor-containing composite material consisting of:
an optical excitable film including a releasable adhesive matrix and a phosphor dispersed in said releasable adhesive matrix, said optical excitable film having opposite first and second exposed adhesive surfaces, said second exposed adhesive surface being adapted to be peelably bonded to an external element; and
a transparent first releasable protection layer bonded to said first exposed adhesive surface;
wherein said transparent first releasable protection layer is peelable from said first exposed adhesive surface, so that when said second exposed adhesive surface is peelably bonded to the external element, said transparent first releasable protection layer being peelable to expose said first exposed adhesive surface.
